(19) United States
(12) Patent Application Publication
(10) Pub. No.: US 2017/0041903 A1
(43) Pub. Date: Feb. 9, 2017

(54) RESOURCE BROADCASTING METHOD AND APPARATUS

(71) Applicant: Huawei Technologies Co., Ltd., Shenzhen (CN)

(72) Inventors: Jie Ma, Beijing (CN); Zhenzhen Cao, Beijing (CN)

(21) Appl. No.: 15/299,700

(22) Filed: Oct. 21, 2016

Related U.S. Application Data
(63) Continuation of application No. PCT/CN2014/075973, filed on Apr. 22, 2014.

(51) Int. Cl. H04W 72/02; H04W 72/04

(52) U.S. Cl. CPC H04W 72/02; H04W 72/0413; H04W 72/0453; H04W 72/0446; H04W 72/082

(57) ABSTRACT

The present invention relates to a resource broadcasting method and apparatus, including: sending a request message of requesting a first frequency domain resource and a first time domain resource that are used for device-to-device D2D communication; obtaining, from the first frequency domain resource obtained by requesting, a second frequency domain resource used for data transmission, and obtaining, from the first time domain resource obtained by requesting, a second time domain resource used for data transmission; and repeatedly sending a declaration message, where the declaration message includes: the second frequency domain resource and the second time domain resource. Therefore, a problem that two terminals occupy a same resource may be resolved.

### CROSS-REFERENCE TO RELATED APPLICATIONS

This application is a continuation of International Application No. PCT/CN2014/075973, filed on Apr. 22, 2014, the disclosure of which is hereby incorporated by reference in its entirety.

### TECHNICAL FIELD

The present invention relates to the mobile communications field, and in particular, to a resource broadcasting method and apparatus.

### BACKGROUND

In the case of relatively perfect coverage of wireless communication, both an operator and a government expect that wireless communication can be used to process some public safety events. After a safety event occurs, an emergency command group and a rescue team perform communication in a specific geographical area, and each group member holds a special terminal. This special terminal is referred to as a device-to-device (D2D) device, which means that the terminal can perform cellular communication with abase station like a common wireless terminal, and can directly communicate with another device-to-device terminal at the same time. Because of block of terrain and a time-varying characteristic of a wireless signal, a coverage hole in cellular coverage actually occurs, and in a public safety requirement, application of a device-to-device terminal needs to be implemented both in the case of network coverage and in the case of no network coverage. Generally, public safety personnel take action per team of multiple persons, which is referred to as a group or a cluster.

In the prior art, when a terminal requests a resource from a base station, the terminal sends a size of content cached by a Media Access Control (MAC) layer of the terminal in a linked state, and the base station allocates a resource to a terminal according to a priority of each terminal and a data amount cached by the terminal. This resource allocating manner causes a same resource to be allocated to terminals. However, for two device-to-device terminals, because geographical locations are very close, using a same resource causes severe interference to a receiving terminal. As a result, data sent by either of the two terminals cannot be received.

### SUMMARY

Embodiments of the present invention provide a resource broadcasting method and apparatus, which can resolve a problem that two terminals occupy a same resource.

According to a first aspect, a resource broadcasting method is provided, where the method includes:

sending a request message of requesting a first frequency domain resource and a first time domain resource that are used for device-to-device D2D communication;

obtaining, from the first frequency domain resource obtained by requesting, a second frequency domain resource used for data transmission, and obtaining, from the first time domain resource obtained by requesting, a second time domain resource used for data transmission; and

repeatedly sending a declaration message, where the declaration message includes: the second frequency domain resource and the second time domain resource.

With reference to the first aspect, in a first implementation manner of the first aspect, the sending, by a terminal, a request message of requesting a frequency domain resource and a time domain resource that are used for D2D communication includes:

sending, to a base station, the request message of requesting the first frequency domain resource and the first time domain resource that are used for D2D communication; or

when a cluster broadcasts a frequency domain resource and a time domain resource that are used by the cluster, sending, to the cluster, the request message of requesting the first frequency domain resource and the first time domain resource that are used for D2D communication.

With reference to the first implementation manner of the first aspect, in a second implementation manner of the first aspect, the sending, to a base station, the request message of requesting the first time domain resource used for D2D communication includes:

sending, to the base station, a request message of requesting a subframe set used for D2D communication; and

the obtaining, from the first time domain resource obtained by requesting, a second time domain resource used for data transmission includes:

obtaining, from the subframe set used for D2D communication, a subframe set used for data transmission.

With reference to the first aspect, or the first implementation manner of the first aspect, or the second implementation manner of the first aspect, in a third implementation manner of the first aspect, the second time domain resource in the repeatedly sent declaration message includes: a second time domain resource used in a current time and a second time domain resource used next time.

With reference to any one of the first aspect, or the foregoing three implementation manners of the first aspect, in a fourth implementation manner of the first aspect, the repeatedly sending a declaration message includes:

repeatedly sending the declaration message by using a Media Access Control control element MAC CE field; or

repeatedly sending the declaration message by using a physical layer sequence.

According to a second aspect, a resource broadcasting method is provided, where the method includes:

broadcasting, by a cluster, a frequency domain resource and a time domain resource that are used by the cluster, so that when receiving the frequency domain resource and the time domain resource, a terminal sends, to the cluster, a request message of requesting a first frequency domain resource and a first time domain resource that are used for device-to-device D2D communication; and

delivering, to the terminal, the first frequency domain resource and the first time domain resource, so that the terminal obtains, from the first frequency domain resource, a second frequency domain resource used for data transmission, and obtains, from the first time domain resource, a second time domain resource used for data transmission; and the first terminal repeatedly sends a declaration message, where the declaration message includes: the second frequency domain resource and the second time domain resource.

With reference to the second aspect, in a first implementation manner of the second aspect, the first time domain resource used for D2D communication is a subframe set used for D2D communication; and

correspondingly, the second time domain resource used for data transmission is a subframe set used for data transmission in the subframe set used for D2D communication.

With reference to the second aspect, or the first implementation manner of the second aspect, in a second implementation manner of the second aspect, the second time domain resource in the repeatedly sent declaration message includes: a second time domain resource used in a current time and a second time domain resource used next time. With reference to any one of the second aspect, or the foregoing two implementation manners of the second aspect, in a third implementation manner of the second aspect, the declaration message is repeatedly sent by using a Media Access Control control element MAC CE field or a physical layer sequence.

According to a third aspect, a resource broadcasting apparatus is provided, where the apparatus includes: a first sending unit, an obtaining unit, and a second sending unit, where

the first sending unit is configured to send a request message of requesting a first frequency domain resource and a first time domain resource that are used for device-to-device D2D communication;

the obtaining unit is configured to obtain, from the first frequency domain resource obtained by requesting, a second frequency domain resource used for data transmission, and obtain, from the first time domain resource obtained by requesting, a second time domain resource used for data transmission; and

the second sending unit is configured to repeatedly send a declaration message, where the declaration message includes: the second frequency domain resource and the second time domain resource.

With reference to the third aspect, in a first implementation manner of the third aspect, the first sending unit is specifically configured to:

send, to a base station, the request message of requesting the first frequency domain resource and the first time domain resource that are used for D2D communication; or

when a cluster broadcasts a frequency domain resource and a time domain resource that are used by the cluster, send, to the cluster, the request message of requesting the first frequency domain resource and the first time domain resource that are used for D2D communication.

With reference to the first implementation manner of the third aspect, in a second implementation manner of the third aspect, the first sending unit is specifically configured to:

send, to the base station, a request message of requesting a subframe set used for D2D communication; and

the obtaining unit is specifically configured to:

obtain, from the subframe set that is obtained by requesting and is used for D2D communication, a subframe set used for data transmission.

With reference to the third aspect, or the first implementation manner of the third aspect, or the second implementation manner of the third aspect, in a third implementation manner of the third aspect, the second time domain resource in the declaration message that is repeatedly sent by the second sending unit includes: a second time domain resource used in a current time and a second time domain resource used next time.

With reference to any one of the third aspect, or the foregoing three implementation manners of the third aspect, in a fourth implementation manner of the third aspect, the second sending unit is specifically configured to:

repeatedly send the declaration message by using a Media Access Control control element MAC CE field; or

repeatedly send the declaration message by using a physical layer sequence.

According to a fourth aspect, a resource broadcasting apparatus is provided, where the apparatus includes: a broadcasting unit and a delivering unit, where

the broadcasting unit is configured to broadcast a frequency domain resource and a time domain resource that are used by a cluster, so that when receiving the frequency domain resource and the time domain resource, a terminal sends, to the cluster, a request message of requesting a first frequency domain resource and a first time domain resource that are used for device-to-device D21D communication; and

the delivering unit is configured to deliver, to the terminal, the first frequency domain resource and the first time domain resource, so that the terminal obtains, from the first frequency domain resource, a second frequency domain resource used for data transmission, and obtains, from the first time domain resource, a second time domain resource used for data transmission; and the first terminal repeatedly sends a declaration message, where the declaration message includes: the second frequency domain resource and the second time domain resource.

With reference to the fourth aspect, in a first implementation manner of the fourth aspect, the first time domain resource used for D2D communication is a subframe set used for D2D communication; and

correspondingly, the second time domain resource used for data transmission is a subframe set used for data transmission in the subframe set used for D2D communication.

With reference to the fourth aspect, or the first implementation manner of the fourth aspect, in a second implementation manner of the fourth aspect, the second time domain resource in the repeatedly sent declaration message includes: a second time domain resource used in a current time and a second time domain resource used next time.

With reference to any one of the fourth aspect, or the foregoing two implementation manners of the fourth aspect, in a third implementation manner of the fourth aspect, the declaration message is repeatedly sent by using a Media Access Control control element MAC CE field or a physical layer sequence.

According to a fifth aspect, a resource broadcasting apparatus is provided, where the apparatus includes:

a network interface;

a processor;

a memory; and

an application program physically stored in the memory, where the application program includes an instruction that may be used by the processor and the apparatus to execute the following processes:

sending a request message of requesting a first frequency domain resource and a first time domain resource that are used for device-to-device D2D communication;

obtaining, from the first frequency domain resource obtained by requesting, a second frequency domain resource used for data transmission, and obtaining, from the first time domain resource obtained by requesting, a second time domain resource used for data transmission; and

repeatedly sending a declaration message, where the declaration message includes: the second frequency domain resource and the second time domain resource.

With reference to the fifth aspect, in a first implementation manner of the fifth aspect, the application program further includes a specific instruction that may be used by the processor and the apparatus to execute the following process:

sending, to a base station, the request message of requesting the first frequency domain resource and the first time domain resource that are used for D2D communication; or

when a cluster broadcasts a frequency domain resource and a time domain resource that are used by the cluster, sending, to the cluster, the request message of requesting the first frequency domain resource and the first time domain resource that are used for D2D communication.

With reference to the first implementation manner of the fifth aspect, in a second implementation manner of the fifth aspect, the application program further includes a specific instruction that may be used by the processor and the apparatus to execute the following process:

sending, to the base station, a request message of requesting a subframe set used for D2D communication; and

the obtaining, from the first time domain resource obtained by requesting, a second time domain resource used for data transmission includes:

obtaining, from the subframe set used for D2D communication, a subframe set used for data transmission.

With reference to the fifth aspect, or the first implementation manner of the fifth aspect, or the second implementation manner of the fifth aspect, in a third implementation manner of the fifth aspect, the second time domain resource in the repeatedly sent declaration message includes: a second time domain resource used in a current time and a second time domain resource used next time.

With reference to any one of the fifth aspect, or the foregoing three implementation manners of the fifth aspect, in a fourth implementation manner of the fifth aspect, the application program further includes a specific instruction that may be used by the processor and the apparatus to execute the following process:

repeatedly sending the declaration message by using a Media Access Control control element MAC CE field; or

repeatedly sending the declaration message by using a physical layer sequence.

According to a sixth aspect, a resource broadcasting apparatus is provided, where the apparatus includes:

a network interface;

a processor;

a memory; and

an application program physically stored in the memory, where the application program includes an instruction that may be used by the processor and the apparatus to execute the following processes:

broadcasting a frequency domain resource and a time domain resource that are used by a cluster, so that when receiving the frequency domain resource and the time domain resource, a terminal sends, to the cluster, a request message of requesting a first frequency domain resource and a first time domain resource that are used for device-to-device D2D communication; and

delivering, to the terminal, the first frequency domain resource and the first time domain resource, so that the terminal obtains, from the first frequency domain resource, a second frequency domain resource used for data transmission, and obtains, from the first time domain resource, a second time domain resource used for data transmission; and the first terminal repeatedly sends a declaration message, where the declaration message includes: the second frequency domain resource and the second time domain resource.

With reference to the sixth aspect, in a first implementation manner of the sixth aspect,

the first time domain resource used for D2D communication is a subframe set used for D2D communication; and

correspondingly, the second time domain resource used for data transmission is a subframe set used for data transmission in the subframe set used for D2D communication.

With reference to the sixth aspect, or the first implementation manner of the sixth aspect, in a second implementation manner of the sixth aspect, the second time domain resource in the repeatedly sent declaration message includes: a second time domain resource used in a current time and a second time domain resource used next time.

With reference to any one of the sixth aspect, or the foregoing two implementation manners of the sixth aspect, in a third implementation manner of the sixth aspect, the declaration message is repeatedly sent by using a Media Access Control control element MAC CE field or a physical layer sequence.

According to the resource broadcasting method and apparatus provided in the embodiments of the present invention, a request message of requesting a first frequency domain resource and a first time domain resource that are used for device-to-device D2D communication is sent; a second frequency domain resource used for data transmission is obtained from the first frequency domain resource obtained by requesting, and a second time domain resource used for data transmission is obtained from the first time domain resource obtained by requesting; and a declaration message is repeatedly sent, where the declaration message includes: the second frequency domain resource and the second time domain resource. Therefore, after requesting a resource, a terminal declares, to another terminal, information about a resource used by the terminal; and another adjacent terminal learns that the resource is to be occupied, and when requesting a resource, bypasses the resource that is to be occupied by the foregoing terminal, thereby resolving a problem that two terminals occupy a same resource.

### BRIEF DESCRIPTION OF THE DRAWINGS

FIG. 1 is a flowchart of a resource broadcasting method according to Embodiment 1 of the present invention;

FIG. 2 is a schematic diagram of carrying a time domain resource by using a physical layer sequence;

FIG. 3 is a flowchart of a resource broadcasting method according to Embodiment 2 of the present invention;

FIG. 4 is a flowchart of a resource broadcasting method according to Embodiment 3 of the present invention;

FIG. 5 is a schematic diagram of a resource broadcasting apparatus according to Embodiment 4 of the present invention;

FIG. 6 is a schematic diagram of a resource broadcasting apparatus according to Embodiment 5 of the present invention;

FIG. 7 is a schematic diagram of a resource broadcasting apparatus according to Embodiment 6 of the present invention; and

FIG. 8 is a schematic diagram of a resource broadcasting apparatus according to Embodiment 7 of the present invention.

### DETAILED DESCRIPTION

The technical solutions of the present invention are further described in detail with reference to accompanying drawings and embodiments as follows:

The method provided in the embodiments of the present invention is applied to a cellular network, and a terminal in the network is referred to as a device-to-device terminal, which means that the terminal can perform cellular communication with a base station like a common wireless terminal, and can directly communicate with another device-to-device terminal at the same time, that is, D2D communication. In the network, when the device-to-device terminal wants to communicate with another terminal by using a D2D technology, the terminal sends, to the base station, a request message of requesting a resource, and the base station allocates an idle resource to the terminal according to content requested by the terminal. The resource may be used for a period of time. After obtaining the resource allocated by the base station, the terminal first declares a frequency domain resource and a time domain resource that are to be used by the terminal, and then sends data.

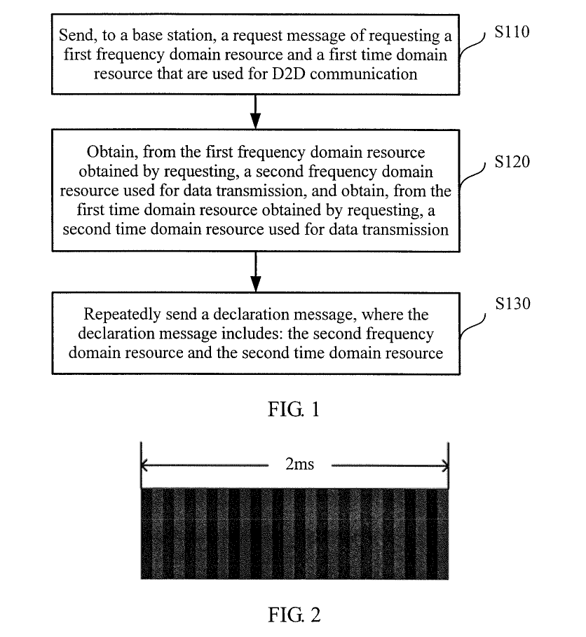

FIG. 1 is a flowchart of a resource broadcasting method according to Embodiment 1 of the present invention. As shown in FIG. 1, the method is executed by a terminal, and the method specifically includes the following steps:

S110. Send, to abase station, a request message of requesting a first frequency domain resource and a first time domain resource that are used for D2D communication.

It should be noted that, the terminal in this embodiment is a D2D terminal. A communication process of the D2D terminal includes two stages: cellular communication and D2D communication, and the two stages are separated in terms of time. Specifically, abase station side divides a time occupied by an entire communication process into several same time periods. The time periods may be but are not limited to 10 ms or several 10 ms, and each time period is represented as a subframe set. Some subframes in the subframe set are used to perform cellular communication, and some other subframes are used to perform D2D communication. The subframes used to perform cellular communication are referred to as a first subframe set, and the subframes used to perform D2D communication are referred to as a second subframe set.

In the foregoing time period, the subframes in the first subframe set and the subframes in the second subframe set may separately occur in terms of time, or may alternately occur in terms of time.

For example, when the foregoing time period is 10 ms, and in a subframe set of 10 ms, the subframes in the first subframe set and the subframes in the second subframe set separately occur in terms of time, the following is shown:

| T₀ | T₁ |
|---|---|
| Subframe in a first subframe set | Subframe in a second subframe set |

In a subframe set of 10 ms, when the subframes in the first subframe set and the subframes in the second subframe set alternately occur in terms of time, the following is shown:

| T₀ | T₁ | T₀ | T₁ |
|---|---|---|---|
| Subframe in | Subframe in | Subframe in | Subframe in |
| a first | a second | a first | a second |
| subframe set | subframe set | subframe set | subframe set |

When there is data that needs to be sent, the terminal needs to request a resource from the base station in a cellular communication stage. The resource includes a first frequency domain resource and a first time domain resource. The first frequency domain resource refers to a frequency resource and a bandwidth and the first time domain resource refers to a subframe used for D2D communication, that is, the second subframe set. Specifically, when the first subframe set is reached, the terminal sends, to the base station, a message of requesting the first frequency domain resource and the second subframe set that are used for D2D communication.

S120. Obtain, from the first frequency domain resource obtained by requesting, a second frequency domain resource used for data transmission, and obtain, from the first time domain resource obtained by requesting, a second time domain resource used for data transmission.

It should be noted that, the D2D communication process of the D2D terminal further includes two stages: resource declaration and data transmission (that is, data sending or receiving). Therefore, to implement time separation for the two stages, generally, some subframes in the second subframe set are used for resource declaration, and some other subframes are used for data transmission. A subframe set used for data transmission is the second time domain resource. Specifically, after requesting and obtaining the first frequency domain resource and the second subframe set from the base station, the terminal further needs to obtain, from the first frequency domain resource, the second frequency domain resource used for data transmission, and obtain, from the second subframe set, the subframe set used for data transmission.

It should be noted that, when using some frequency resources for the D2D communication, the base station divides the some frequency resources into time-frequency blocks that carry fewer bits. One identifier is allocated to each time-frequency block. The identifier is referred to as a resource declaration identifier index. Specifically, the obtaining, from the first frequency domain resource, the second frequency domain resource used for data transmission includes: obtaining an available resource declaration identifier index from the base station. Data of a terminal side is sent by using a time-frequency block corresponding to the obtained resource declaration identifier index.

S130. Repeatedly send a declaration message, where the declaration message includes: the second frequency domain resource and the second time domain resource.

Generally, the base station side further sets a quantity of times of sending the declaration message and a quantity of times of repeatedly sending each data packet, and the terminal repeatedly sends the second frequency domain resource and the second time domain resource according to the quantity of times of sending the declaration message, which can ensure that a terminal newly added to a cellular network may also receive a message indicating the second frequency domain resource and the second time domain resource that are used by the foregoing terminal, thereby improving reliability.

Specifically, the terminal repeatedly sends the declaration message by using a MAC control element (Control Elements, CE) field.

Optionally, the second time domain resource in the repeatedly sent declaration message includes: a second time domain resource used in a current time and a second time domain resource used next time. For example, content of the declaration message that is repeatedly sent by the terminal is: groupid, service type, TX time. groupid indicates an identifier of a service group to which the terminal belongs; service type indicates a data service type, including: a voice, a picture, a video stream, or the like; and TX time indicates, in two consecutive time periods, a subframe used for data transmission in the second subframe set in a current time period and a subframe used for data transmission in the second subframe set in a next time period, which is specifically implemented in multiple forms. Example 1: when locations of subframes used for data transmission in the second subframe set in each time period are the same, TX time includes two parts: a subframe number used for data transmission in the second subframe set+a bit identifier indicating whether the second frequency domain resource used for data transmission in next two times is occupied. The bit identifier is: 11, which indicates occupation in both of the two times; 10, which indicates occupation in the current time, and no occupation in the next time; and 01, which indicates no occupation in the current time, but occupation in the next time. In the case of no occupation in both of the next two times, the terminal does not send the declaration message. Example 2: when locations of subframes used for data transmission in the second subframe set in each time period are different, TX time includes two parts: a subframe number used for data transmission in the second subframe set in the current time period, and a subframe number used for data transmission in the second subframe set in the next time period.

After repeatedly sending the declaration message, the terminal may repeatedly send data according to the quantity of times of repeatedly sending each data packet that is set by the base station.

In addition, the terminal may further repeatedly send the second frequency domain resource and the second time domain resource by using a physical layer sequence. For example, referring to a schematic diagram of carrying a time domain resource by using a physical layer sequence shown in FIG. 2, a time period for resource declaration is shortened, which is only 2 ms. In addition, one resource block may carry 14 sequences in the time of 2 ms and each sequence location is corresponding to one subframe location used for data transmission. Therefore, a quantity of subframes used for data transmission and a quantity of sequence locations in the time period for resource declaration are the same and in a one-to-one correspondence. In FIG. 2, there are four numbers in total in the sequence, which are 1, 2, 3, and 4 respectively. 4 indicates occupation in both of the two times, 3 indicates occupation in the current time, and no occupation in the next time; 2 indicates no occupation in the current time, but occupation in the next time; and 1 indicates no occupation in either of the two times. Specifically, when repeatedly sending the declaration message, the terminal declares, to another terminal by sending a series of numbers, a second time domain resource occupied by the terminal, that is, the subframe set used for data transmission.

According to the resource broadcasting method provided in this embodiment of the present invention, after obtaining a resource allocated by a base station, a terminal first claims a frequency domain resource and a time domain resource that are to be used by the terminal, and then sends data. Therefore, a problem that two terminals occupy a same resource is resolved.

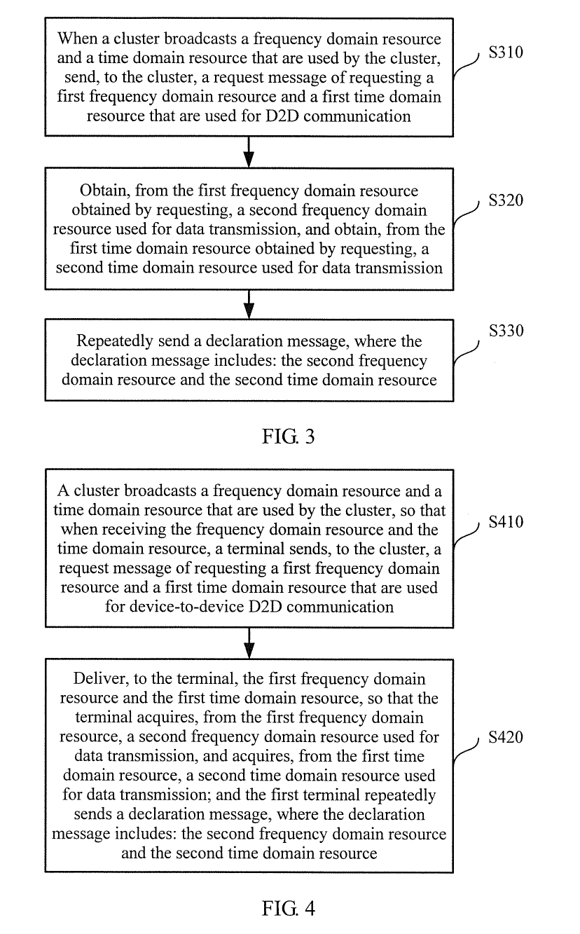

FIG. 3 is a flowchart of a resource broadcasting method according to Embodiment 2 of the present invention. As shown in FIG. 3, the method is executed by a terminal, and the method specifically includes the following steps:

S310. When a cluster broadcasts a frequency domain resource and a time domain resource that are used by the cluster, the cluster sends a request message of requesting a first frequency domain resource and a first time domain resource that are used for D2D communication.

In the case of no network coverage, a group of resources in a resource pool is preconfigured for the cluster, and a possible manner is: one resource, or multiple or even all resources. After reaching a preset geographical area, a cluster head first broadcasts a frequency domain resource and a time domain resource that are used by the cluster. The frequency domain resource is the foregoing preconfigured group of resources in the resource pool, and the time domain resource is a subframe set used by the cluster. Specifically, the cluster divides the subframe set used by the cluster into multiple subsets, and a specific format is shown as follows:

| T₀ | T₁ | T₂ | T₃ | T₄ | T₂′ |
|---|---|---|---|---|---|
| Declaring | A terminal | The | The | The | The |
| a resource | requests | terminal | cluster | terminal | terminal |
| frame | the | sends a | responds | sends a | sends the |
| | resource | data | to the | declaration | data frame |
| | frame from a | frame | resource | message | |
| | cluster | | frame | frame | |
| | | | request | | |

Specifically, the cluster sends a declaration message in a T₀ time period. The declaration message includes the frequency domain resource and the time domain resource that are used by the cluster; after the terminal receives the foregoing declaration message, if there is data that is to be sent, the terminal sends, to the cluster in a T₁ time period, the request message of requesting the first frequency domain resource and the first time domain resource that are used for D2D communication; and in a T₃ time period, the cluster delivers an allocation message to all terminals that request a resource. The allocation message includes the first frequency domain resource and the first time domain resource that are used by the terminal to perform D2D communication.

S320-S330 are the same as S120-S130.

It should be noted that, a second time domain resource in S320 is also a subframe set that may be used by the terminal in T₂ and T₂′ time periods; in S330, the terminal repeatedly sends the declaration message in a T₄ time period.

According to the resource broadcasting method provided in this embodiment, in the case of no network coverage, a terminal can still perform normal communication, thereby resolving a problem that the terminal cannot be properly used due to a time-varying characteristic of a wireless signal.

FIG. 4 is a flowchart of a resource broadcasting method according to Embodiment 3 of the present invention. As shown in FIG. 4, the method is executed by a cluster, and the method specifically includes the following steps:

S410. A cluster broadcasts a frequency domain resource and a time domain resource that are used by the cluster, so that when receiving the frequency domain resource and the time domain resource, a terminal sends, to the cluster, a request message of requesting a first frequency domain resource and a first time domain resource that are used for device-to-device D2D communication.

Optionally, the first time domain resource used for D2D communication is a subframe set used for D2D communication; and

correspondingly, the second time domain resource used for data transmission is a subframe set used for data transmission in the subframe set used for D2D communication.

S420. Deliver, to the terminal, the first frequency domain resource and the first time domain resource, so that the terminal obtains, from the first frequency domain resource, a second frequency domain resource used for data transmission, and obtains, from the first time domain resource, a second time domain resource used for data transmission; and the first terminal repeatedly sends a declaration message, where the declaration message includes: the second frequency domain resource and the second time domain resource.

Optionally, the second time domain resource in the repeatedly sent declaration message includes: a second time domain resource used in a current time and a second time domain resource used next time.

Optionally, the declaration message is repeatedly sent by using a Media Access Control control element MAC CE field or a physical layer sequence.

According to the resource broadcasting method provided in this embodiment, in the case of no network coverage, a terminal can still perform normal communication, thereby resolving a problem that the terminal cannot be properly used due to a time-varying characteristic of a wireless signal.

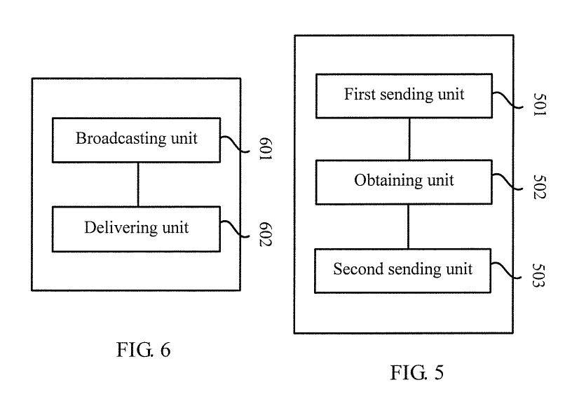

FIG. 5 is a schematic diagram of a resource broadcasting apparatus according to Embodiment 4 of the present invention. The apparatus may be configured to execute the method described in FIG. 1 or FIG. 3. In FIG. 5, the apparatus includes: a first sending unit 501, an obtaining unit 502, and a second sending unit 503.

The first sending unit 501 is configured to send a request message of requesting a first frequency domain resource and a first time domain resource that are used for device-to-device D2D communication.

The first sending unit 501 is specifically configured to: send, to a base station, the request message of requesting the first frequency domain resource and the first time domain resource that are used for D2D communication; or, when a cluster broadcasts a frequency domain resource and a time domain resource that are used by the cluster, send, to the cluster, the request message of requesting the first frequency domain resource and the first time domain resource that are used for D2D communication.

The first sending unit 501 is further specifically configured to send, to the base station, a request message of requesting a subframe set used for D2D communication.

The obtaining unit 502 is configured to obtain, from the first frequency domain resource obtained by requesting, a second frequency domain resource used for data transmission, and obtain, from the first time domain resource obtained by requesting, a second time domain resource used for data transmission.

The obtaining unit 502 is specifically configured to obtain, from the subframe set that is obtained by requesting and is used for D2D communication, a subframe set used for data transmission.

The second sending unit 503 is configured to repeatedly send a declaration message, where the declaration message includes: the second frequency domain resource and the second time domain resource.

The second time domain resource in the declaration message that is repeatedly sent by the second sending unit 503 includes: a second time domain resource used in a current time and a second time domain resource used next time.

The second sending unit 503 is specifically configured to:

repeatedly send the declaration message by using a Media Access Control control element MAC CE field; or

repeatedly send the declaration message by using a physical layer sequence.

According to the resource broadcasting apparatus provided in this embodiment of the present invention, after obtaining a resource allocated by a base station, a terminal first declares a frequency domain resource and a time domain resource that are to be used by the terminal, and then sends data. Therefore, a problem that two terminals occupy a same resource is resolved.

FIG. 6 is a schematic diagram of a resource broadcasting apparatus according to Embodiment 5 of the present invention. The apparatus may be configured to execute the method described in FIG. 4. In FIG. 6, the apparatus includes: a broadcasting unit 601 and a delivering unit 602.

The broadcasting unit 601 is configured to broadcast a frequency domain resource and a time domain resource that are used by a cluster, so that when receiving the frequency domain resource and the time domain resource, a terminal sends, to the cluster, a request message of requesting a first frequency domain resource and a first time domain resource that are used for device-to-device D2D communication.

The delivering unit 602 is configured to deliver, to the terminal, the first frequency domain resource and the first time domain resource, so that the terminal obtains, from the first frequency domain resource, a second frequency domain resource used for data transmission, and obtains, from the first time domain resource, a second time domain resource used for data transmission; and the first terminal repeatedly sends a declaration message, where the declaration message includes: the second frequency domain resource and the second time domain resource.

Optionally, the first time domain resource used for D2D communication is a subframe set used for D2D communication; and

correspondingly, the second time domain resource used for data transmission is a subframe set used for data transmission in the subframe set used for D2D communication.

Optionally, the second time domain resource in the repeatedly sent declaration message includes: a second time domain resource used in a current time and a second time domain resource used next time.

Optionally, the declaration message is repeatedly sent by using a Media Access Control control element MAC CE field or a physical layer sequence.

According to the resource broadcasting apparatus provided in this embodiment of the present invention, in the case of no network coverage, a terminal can still perform normal communication, thereby resolving a problem that the terminal cannot be properly used due to a time-varying characteristic of a wireless signal.

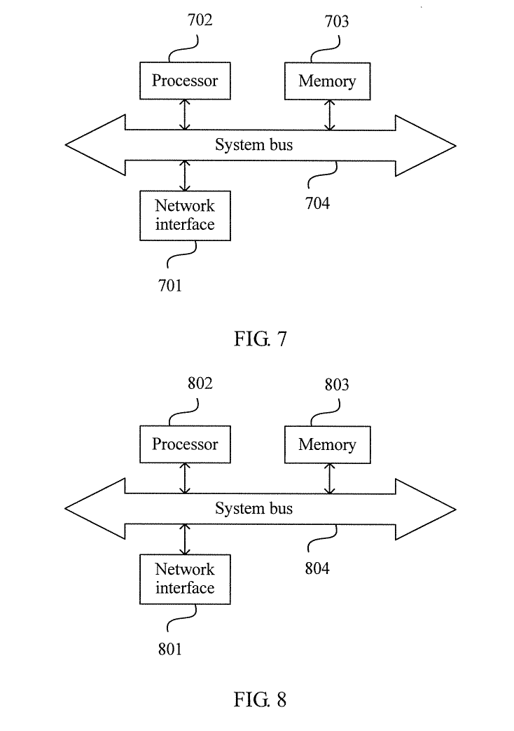

FIG. 7 is a schematic diagram of a resource broadcasting apparatus according to Embodiment 6 of the present invention. As shown in FIG. 7, the apparatus includes a network interface 701, a processor 702, and a memory 703. A system bus 704 is configured to connect the network interface 701, the processor 702, and the memory 703.

For example, the processor 702 may be a CPU.

The network interface 701 is configured to communicate with another device.

The memory 703 may be a permanent memory, for example, a hard disk drive and a flash memory, and the memory 703 has a software module and a device driver. The software module can implement various functions of the foregoing method of the present invention, and the device driver may be a network and interface driver.

Upon startup, these software components are loaded into the memory 703 and then are accessed by the processor 702 to execute the following instructions:

sending a request message of requesting a first frequency domain resource and a first time domain resource that are used for device-to-device D2D communication;

obtaining, from the first frequency domain resource obtained by requesting, a second frequency domain resource used for data transmission, and obtaining, from the first time domain resource obtained by requesting, a second time domain resource used for data transmission; and

repeatedly sending a declaration message, where the declaration message includes: the second frequency domain resource and the second time domain resource.

Further, an application program further includes an instruction that may be used by the processor 702 and the apparatus to execute the following process:

sending, to a base station, the request message of requesting the first frequency domain resource and the first time domain resource that are used for D2D communication; or

when a cluster broadcasts a frequency domain resource and a time domain resource that are used by the cluster, sending, to the cluster, the request message of requesting the first frequency domain resource and the first time domain resource that are used for D2D communication.

Further, the application program further includes an instruction that may be used by the processor 702 and the apparatus to execute the following process:

sending, to the base station, a request message of requesting a subframe set used for D2D communication.

The obtaining, from the first time domain resource obtained by requesting, a second time domain resource used for data transmission includes:

obtaining, from the subframe set used for D2D communication, a subframe set used for data transmission.

Optionally, the second time domain resource in the repeatedly sent declaration message includes: a second time domain resource used in a current time and a second time domain resource used next time.

Further, the application program further includes an instruction that may be used by the processor 702 and the apparatus to execute the following process:

repeatedly sending the declaration message by using a Media Access Control control element MAC CE field; or

repeatedly sending the declaration message by using a physical layer sequence.

According to the resource broadcasting apparatus provided in this embodiment of the present invention, after obtaining a resource allocated by a base station, a terminal first claims a frequency domain resource and a time domain resource that are to be used by the terminal, and then sends data. Therefore, a problem that two terminals occupy a same resource is resolved.

FIG. 8 is a schematic diagram of a resource broadcasting apparatus according to Embodiment 7 of the present invention. As shown in FIG. 8, the apparatus includes a network interface 801, a processor 802, and a memory 803. A system bus 804 is configured to connect the network interface 801, the processor 802, and the memory 803.

For example, the processor 802 may be a CPU.

The network interface 801 is configured to communicate with another device.

The memory 803 may be a permanent memory, for example, a hard disk drive and a flash memory, and the memory 803 has a software module and a device driver. The software module can implement various functions of the foregoing method of the present invention, and the device driver may be a network and interface driver.

Upon startup, these software components are loaded into the memory 803 and then are accessed by the processor 802 to execute the following instructions:

broadcasting a frequency domain resource and a time domain resource that are used by a cluster, so that when receiving the frequency domain resource and the time domain resource, a terminal sends, to the cluster, a request message of requesting a first frequency domain resource and a first time domain resource that are used for device-to-device D2D communication; and

delivering, to the terminal, the first frequency domain resource and the first time domain resource, so that the terminal obtains, from the first frequency domain resource, a second frequency domain resource used for data transmission, and obtains, from the first time domain resource, a second time domain resource used for data transmission; and the first terminal repeatedly sends a declaration message, where the declaration message includes: the second frequency domain resource and the second time domain resource.

Optionally, the first time domain resource used for D2D communication is a subframe set used for D2D communication; and

correspondingly, the second time domain resource used for data transmission is a subframe set used for data transmission in the subframe set used for D2D communication.

Optionally, the second time domain resource in the repeatedly sent declaration message includes: a second time domain resource used in a current time and a second time domain resource used next time.

Optionally, the declaration message is repeatedly sent by using a Media Access Control control element MAC CE field or a physical layer sequence.

According to the resource broadcasting apparatus provided in this embodiment of the present invention, in the case of no network coverage, a terminal can still perform normal communication, thereby resolving a problem that the terminal cannot be properly used due to a time-varying characteristic of a wireless signal.

A person skilled in the art may be further aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

Steps of methods or algorithms described in the embodiments disclosed in this specification may be implemented by hardware, a software module executed by a processor, or a combination thereof. The software module may reside in a random access memory (RAM), a memory, a read-only memory (ROM), an electrically programmable ROM, an electrically erasable programmable ROM, a register, a hard disk, a removable disk, a CD-ROM, or any other form of storage medium known in the art.

In the foregoing specific implementation manners, the objective, technical solutions, and benefits of the present invention are further described in detail. It should be understood that the foregoing descriptions are merely specific implementation manners of the present invention, but are not intended to limit the protection scope of the present invention. Any modification, equivalent replacement, or improvement made without departing from the spirit and principle of the present invention should fall within the protection scope of the present invention.

What is claimed is:

1. A resource broadcasting method, comprising:
sending a request message for requesting a first frequency domain resource and a first time domain resource that are used for device-to-device (D2D) communication;
obtaining, from the first frequency domain resource, a second frequency domain resource used for data transmission, and obtaining, from the first time domain resource, a second time domain resource used for data transmission; and
repeatedly sending a declaration message comprising the second frequency domain resource and the second time domain resource.

2. The method according to claim 1, wherein sending a request message for requesting a frequency domain resource and a time domain resource that are used for D2D communication comprises:
sending the request message to a base station; or
when a cluster broadcasts a frequency domain resource and a time domain resource that are used by the cluster, sending the request message to the cluster.

3. The method according to claim 2, wherein:
sending the request message to a base station comprises:
sending, to the base station, a request message of requesting a subframe set used for D2D communication; and
obtaining, from the first time domain resource obtained by requesting, a second time domain resource used for data transmission comprises:
obtaining, from the subframe set used for D2D communication, a subframe set used for data transmission.

4. The method according to claim 1, wherein the second time domain resource in the repeatedly sent declaration message comprises:
a second time domain resource used in a current time and a second time domain resource used next time.

5. The method according to claim 1, wherein repeatedly sending a declaration message comprises:
repeatedly sending the declaration message by using a Media Access Control control element (MAC CE) field; or
repeatedly sending the declaration message by using a physical layer sequence.

6. A resource broadcasting method, comprising:
broadcasting, by a cluster, a frequency domain resource and a time domain resource that are used by the cluster, so that when receiving the frequency domain resource and the time domain resource, a terminal sends, to the cluster, a request message for requesting a first frequency domain resource and a first time domain resource that are used for device-to-device (D2D) communication; and
delivering, to the terminal, the first frequency domain resource and the first time domain resource, so that the terminal obtains, from the first frequency domain resource, a second frequency domain resource used for data transmission, and obtains, from the first time domain resource, a second time domain resource used for data transmission, and a first terminal repeatedly sends a declaration message comprising the second frequency domain resource and the second time domain resource.

7. The method according to claim 6, wherein:
the first time domain resource used for D2D communication is a subframe set used for D2D communication; and
correspondingly, the second time domain resource used for data transmission is a subframe set used for data transmission in the subframe set used for D2D communication.

8. The method according to claim 6, wherein the second time domain resource in the repeatedly sent declaration message comprises:
a second time domain resource used in a current time and a second time domain resource used next time.

9. The method according to claim 6, wherein the declaration message is repeatedly sent by using a Media Access Control control element (MAC CE) field or a physical layer sequence.

10. A resource broadcasting apparatus, comprising:
a network interface;
a processor;
a memory; and
an application program physically stored in the memory, wherein the application program comprises instructions that, when executed by the processor, cause the apparatus to:
send a request message for requesting a first frequency domain resource and a first time domain resource that are used for device-to-device (D2D) communication,
obtain, from the first frequency domain resource, a second frequency domain resource used for data transmission, and obtain, from the first time domain resource, a second time domain resource used for data transmission, and
repeatedly send a declaration message comprising the second frequency domain resource and the second time domain resource.

11. The apparatus according to claim 10, wherein the application program further comprises instructions that, when executed by the processor, cause the apparatus to:
send the request message to a base station; or
when a cluster broadcasts a frequency domain resource and a time domain resource that are used by the cluster, send the request message to the cluster.

12. The apparatus according to claim 11, wherein the application program further comprises instructions that, when executed by the processor, cause the apparatus to:
send, to the base station, a request message for requesting a subframe set used for D2D communication; and
obtain, from the base station, a subframe set used for data transmission.

13. The apparatus according to claim 10, wherein the second time domain resource in the repeatedly sent declaration message comprises: a second time domain resource used in a current time and a second time domain resource used next time.

14. The apparatus according to claim 10, wherein the application program further comprises instructions that, when executed by the processor, cause the apparatus to:
repeatedly send the declaration message by using a Media Access Control control element (MAC CE) field; or
repeatedly send the declaration message by using a physical layer sequence.

15. A resource broadcasting apparatus, comprising:
a network interface;
a processor;
a memory; and
an application program physically stored in the memory, wherein the application program comprises instructions that, when executed by the processor, cause the apparatus to:
broadcast a frequency domain resource and a time domain resource that are used by a cluster, so that when receiving the frequency domain resource and the time domain resource, a terminal sends, to the cluster, a request message of requesting a first frequency domain resource and a first time domain resource that are used for device-to-device (D2D) communication, and
deliver, to the terminal, the first frequency domain resource and the first time domain resource, so that the terminal obtains, from the first frequency domain resource, a second frequency domain resource used for data transmission, and obtains, from the first time domain resource, a second time domain resource used for data transmission, and a first terminal repeatedly sends a declaration message comprising the second frequency domain resource and the second time domain resource.

16. The apparatus according to claim 15, wherein:
the first time domain resource used for D2D communication is a subframe set used for D2D communication; and
correspondingly, the second time domain resource used for data transmission is a subframe set used for data transmission in the subframe set used for D2D communication.

17. The apparatus according to claim 15, wherein the second time domain resource in the repeatedly sent declaration message comprises:
a second time domain resource used in a current time and a second time domain resource used next time.

18. The apparatus according to claim 15, wherein the declaration message is repeatedly sent by using a Media Access Control control element (MAC CE) field or a physical layer sequence.
